(19) United States
(12) Patent Application Publication
(10) Pub. No.: US 2024/0287970 A1
(43) Pub. Date: Aug. 29, 2024

(54) DRILLING EQUIPMENT POWERED BY GEOTHERMAL ENERGY

(71) Applicant: EnhancedGEO Holdings, LLC, St. Petersburg, FL (US)

(72) Inventors: Greg Lindberg, Thonotosassa, FL (US); Kimberly C. Conner, Wetumpka, AL (US)

(21) Appl. No.: 18/588,288

(22) Filed: Feb. 27, 2024

Related U.S. Application Data
(60) Provisional application No. 63/448,929, filed on Feb. 28, 2023.

(51) Int. Cl. F03G 4/00; E21B 7/12; F03G 4/04; F24T 10/20

(52) U.S. Cl. CPC F03G 4/029; E21B 7/12; F03G 4/04; F24T 10/20

(57) ABSTRACT

A drilling system includes a wellbore extending from a surface into a geothermal reservoir. The geothermal reservoir may be an underground magma reservoir. The wellbore is configured to heat a heat transfer fluid via heat transfer with the underground magma reservoir. A steam-powered motor uses the heat transfer fluid that is heated by the geothermal system to rotate a drill bit to drill a borehole.

### CROSS-REFERENCE TO RELATED APPLICATIONS

This application claims priority to U.S. Provisional Application No. 63/448,929, filed Feb. 28, 2023, which is hereby incorporated herein by reference in its entirety.

### TECHNICAL FIELD

The present disclosure relates generally to geothermal systems and related methods, and more particularly to drilling equipment powered by geothermal energy.

### BACKGROUND

Holes are drilled into the Earth to access resources, such as oil, gas, water, or heat from below the Earth's surface. Considerable energy is expended to power the equipment used to perform such drilling. Renewable energy sources, such as solar power and wind power, can be unreliable and have relatively low power densities, such that they may be insufficient to reliably power drilling equipment. As such, drilling equipment typically relies on non-renewable fuels for power.

### SUMMARY

This disclosure recognizes the previously unidentified and unmet need for a reliable renewable energy source for drilling equipment. This disclosure provides a solution to this unmet need in the form of drilling equipment that is powered at least partially by geothermal energy. A geothermal system harnesses heat from a geothermal resource with a sufficiently high temperature that can be used to power equipment used in drilling processes. For example, steam may be obtained from a geothermal system, and one or more steam-powered motors may be powered with the steam and used to support operations used to drill a borehole. For example, a steam-powered motor may cause rotation of a drill bit that is used to drill into the Earth. The same or a different steam-powered motor may move the drill bit downwards to facilitate the drilling process. Similarly, the same or a different steam-powered motor may power a pump that is used to cycle drilling fluid through the borehole being drilled. One or more turbines may be powered by the steam to provide electricity for any electronic components of the drilling equipment (e.g., electronic controllers, sensors, etc.).

In some embodiments, the geothermal system that powers the drilling equipment is a closed geothermal system that exchanges heat with a geothermal reservoir. The geothermal reservoir may be on the surface, such as lava, lava flow, or body of lava. The geothermal reservoir may be an underground geothermal reservoir. For example, an underground geothermal reservoir, such as a magma reservoir, may facilitate the generation of high-temperature, high-pressure steam, while avoiding problems and limitations associated with previous geothermal technology. The geothermal systems of this disclosure generally include a wellbore that extends from a surface into an underground thermal reservoir, such as a magma. A closed heat-transfer loop is employed in which a heat transfer fluid is pumped into the wellbore, heated via contact with the underground thermal reservoir, and returned to the surface to power drilling equipment located within a sufficient proximity to the wellbore.

The geothermal system of this disclosure may harness a geothermal resource with sufficiently high amounts of energy from magmatic activity such that the geothermal resource does not degrade significantly over time. This disclosure illustrates improved systems and methods for capturing energy from magma reservoirs, dikes, sills, and other magmatic formations that are significantly higher in temperature than heat sources that are accessed using previous geothermal technologies and that can contain an order of magnitude higher energy density than the geothermal fluids that power previous geothermal technologies. In some cases, the present disclosure can significantly decrease borehole production costs and/or reliance on non-renewable resources for drilling operations. In some cases, the present disclosure may facilitate more efficient drilling in regions where access to reliable power is currently unavailable or transport of non-renewable fuels is challenging. The systems and methods of the present disclosure may also or alternatively aid in decreasing carbon emissions.

Certain embodiments may include none, some, or all of the above technical advantages. One or more technical advantages may be readily apparent to one skilled in the art from figures, description, and claims included herein.

### BRIEF DESCRIPTION OF THE FIGURES

For a more complete understanding of the present disclosure, reference is now made to the following description, taken in conjunction with the accompanying drawings and detailed description, in which like reference numerals represent like parts.

FIG. 1 is a diagram of underground regions near a tectonic plate boundary in the Earth.

FIG. 2 is a diagram of a previous geothermal system.

FIG. 3 is a diagram of an example improved geothermal system of this disclosure.

FIG. 4 is a diagram of an example drilling system in which drilling equipment is powered by the improved geothermal system of FIG. 3.

FIG. 5 is a diagram of example drilling equipment of the system of FIG. 4 in greater detail.

FIG. 6 is a diagram of an example thermally powered motor of the drilling equipment of FIG. 5 in greater detail.

FIG. 7 is a diagram of another example thermally powered motor of the drilling equipment of FIG. 5 in greater detail.

FIG. 8 is a flowchart of an example method for operating the system of FIG. 4.

FIG. 9 is a diagram of an example system for performing thermal or heat-driven processes of FIGS. 3 and 4.

### DETAILED DESCRIPTION

Embodiments of the present disclosure and its advantages will become apparent from the following detailed description when considered in conjunction with the accompanying figures. In the figures, each identical, or substantially similar component that is illustrated in various figures is represented by a single numeral or notation. For purposes of clarity, not every component is labeled in every figure, nor is every component of each embodiment shown where illustration is not necessary to allow those of ordinary skill in the art to understand the disclosure.

As used herein, “magma” refers to extremely hot liquid and semi-liquid rock under the Earth's surface. Magma is formed from molten or semi-molten rock mixture found typically between 1 km to 10 km under the surface of the Earth. However, magma can be found at shallower depths in some cases. As used herein, “borehole” refers to, including oil, gas, water, or heat from below the surface of the Earth. As used herein, a “wellbore” refers to a borehole either alone or in combination with one or more other components disposed within or in connection with the borehole. In some cases, the terms “wellbore” and “borehole” are used interchangeably. As used herein, “fluid conduit” refers to any structure, such as a pipe, tube, or the like, used to transport fluids. As used herein, “heat transfer fluid” refers to a fluid, e.g., a gas or liquid, that takes part in heat transfer by serving as an intermediary in cooling on one side of a process, transporting and storing thermal energy, and heating on another side of a process. Heat transfer fluids are used in processes involving heating or cooling.

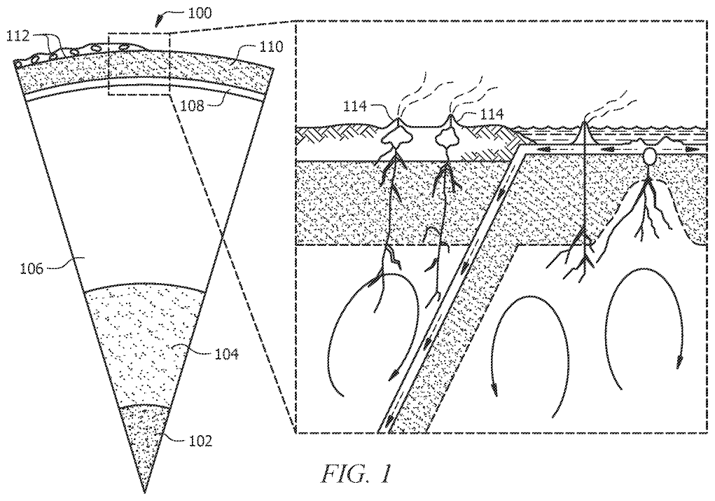

FIG. 1 is a partial cross-sectional diagram 100 of the Earth depicting underground formations that can be tapped by geothermal systems of this disclosure (e.g., for generating geothermal power). The Earth is composed of an inner core 102, outer core 104, lower mantle 106, transitional region 108, upper mantle 110, and crust 112. There are places on the Earth where magma reaches the surface of the crust 112 forming volcanoes 114. However, in most cases, magma approaches only within a few miles or less from the surface. This magma can heat ground water to temperatures sufficient for certain geothermal power production. However, for other applications, such as geothermal energy production, more direct heat transfer with magma is desirable.

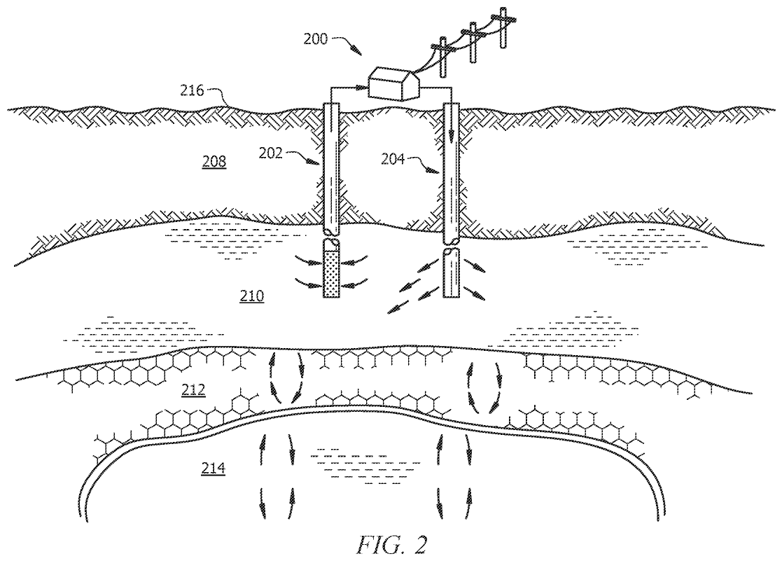

FIG. 2 illustrates a conventional geothermal system 200 that harnesses energy from heated ground water for power generation. The conventional geothermal system 200 is a “flash-plant” that generates power from a high-temperature, high-pressure geothermal water extracted from a production well 202. The production well 202 is drilled through rock layer 208 and into the hydrothermal layer 210 that serves as the source of geothermal water. The geothermal water is heated indirectly via heat transfer with intermediate layer 212, which is in turn heated by magma reservoir 214. Magma reservoir 214 can be any underground region containing magma such as a dike, sill, or the like. Convective heat transfer (illustrated by the arrows indicating that hotter fluids rise to the upper portions of their respective layers before cooling and sinking, then rising again) may facilitate heat transfer between these layers. Geothermal water from the hydrothermal layer 210 flows to the surface 216 and is used for geothermal power generation. The geothermal water (and possibly additional water or other fluids) is then injected back into the hydrothermal layer 210 via an injection well 204.

The configuration of conventional geothermal system 200 of FIG. 2 suffers from drawbacks and disadvantages, as recognized by this disclosure. For example, because geothermal water is a multicomponent mixture (i.e., not pure water), the geothermal water flashes at various points along its path up to the surface 216, creating water hammer, which results in a large amount of noise and potential damage to system components. The geothermal water is also prone to causing scaling and corrosion of system components. Chemicals may be added to partially mitigate these issues, but this may result in considerable increases in operational costs and increased environmental impacts, since these chemicals are generally introduced into the environment via injection well 204.

### Example Improved Geothermal System

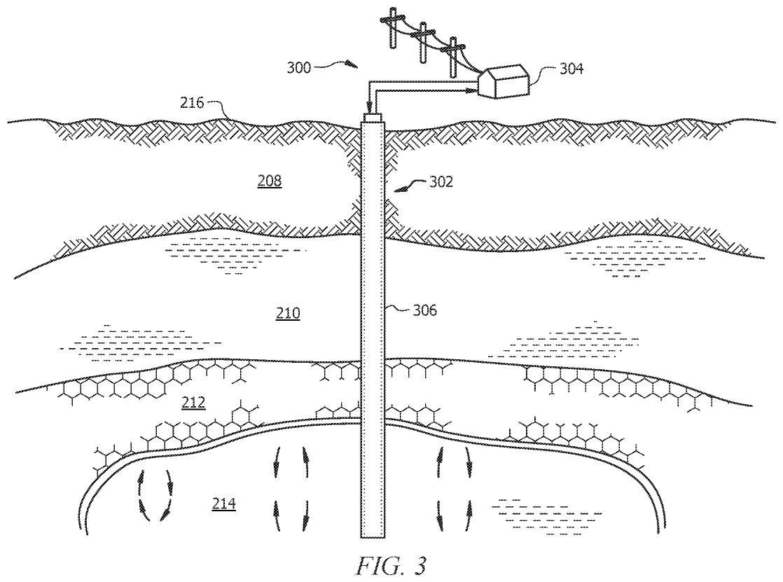

FIG. 3 illustrates an example magma-based geothermal system 300 of this disclosure. The magma-based geothermal system 300 includes a wellbore 302 that extends from the surface 216 at least partially into the magma reservoir 214. A heat exchanger 306 may be located inside the wellbore 302. The magma-based geothermal system 300 is a closed system in which a heat transfer fluid is provided down the wellbore 302 to be heated and returned to a thermal process system 304 (e.g., for power generation and/or any other thermal processes of interest). As such, geothermal water is not extracted from the Earth, resulting in significantly reduced risks associated with the conventional geothermal system 200 of FIG. 2, as described further below. Heated heat transfer fluid is provided to the thermal process system 304. The thermal process system 304 is generally any system that uses the heat transfer fluid to drive a process of interest. For example, the thermal process system 304 may include an electricity generation system and/or support thermal processes requiring higher temperatures/pressures than could be reliably or efficiently obtained using previous geothermal technology, such as the conventional geothermal system 200 of FIG. 2. Further details of components of an example thermal process system 304 are provided with respect to FIG. 9 below.

The magma-based geothermal system 300 provides technical advantages over previous geothermal systems, such as the conventional geothermal system 200 of FIG. 2. The magma-based geothermal system 300 can achieve higher temperatures and pressures for increased energy generation and/or for more effectively driving other thermal processes, such as for powering drilling operations, as described further below. For example, because of the high energy density of magma in magma reservoir 214 (e.g., compared to that of geothermal water of the hydrothermal layer 210), wellbore 302 can generally create the power of many wells of the conventional geothermal system 200 of FIG. 2. Furthermore, the heat transfer fluid is generally not substantially released into the hydrothermal zone, resulting in a decreased environmental impact and decreased use of costly materials (e.g., chemical additives that are used and introduced to the environment in great quantities during some conventional geothermal operations). The magma-based geothermal system 300 may also have a simplified design and operation compared to those of previous systems. For instance, fewer components and reduced complexity may be needed at the thermal process system 304 because only relatively clean heat transfer fluid (e.g., steam) reaches the surface 216. There may be no need or a reduced need to separate out solids or other impurities that are common to geothermal water. The example magma-based geothermal system 300 may include further components not illustrated in FIG. 3.

Further details and examples of different configurations of geothermal systems and methods of their design, preparation, construction, and operation are described in U.S. patent application Ser. No. 18/099,499, filed Jan. 20, 2023, and titled “Geothermal Power from Superhot Geothermal Fluid and Magma Reservoirs”; U.S. patent application Ser. No. 18/099,509, filed Jan. 20, 2023, and titled “Geothermal Power from Superhot Geothermal Fluid and Magma Reservoirs”; U.S. patent application Ser. No. 18/099,514, filed Jan. 20, 2023, and titled “Geothermal Power from Superhot Geothermal Fluid and Magma Reservoirs”; U.S. patent application Ser. No. 18/099,518, filed Jan. 20, 2023, and titled “Geothermal Power from Superhot Geothermal Fluid and Magma Reservoirs”; U.S. patent application Ser. No. 18/105,674, filed Feb. 3, 2023, and titled “Wellbore for Extracting Heat from Magma Chambers”; U.S. patent application Ser. No. 18/116,693, filed Mar. 2, 2023, and titled “Geothermal Systems and Methods with an Underground Magma Chamber”; U.S. patent application Ser. No. 18/116,697, filed Mar. 2, 2023, and titled “Method and System for Preparing a Geothermal System with a Magma Chamber”; U.S. patent application Ser. No. 18/195,810, filed May 10, 2023, and titled “Reverse-Flow Magma-Based Geothermal Generation”, U.S. patent application Ser. No. 18/195,814, filed May 10, 2023, and titled “Partially Cased Wellbore in Magma Reservoir”; U.S. patent application Ser. No. 18/195,822, filed May 10, 2023, and titled “Geothermal System With a Pressurized Chamber in a Magma Wellbore”; U.S. patent application Ser. No. 18/195,828, filed May 10, 2023, and titled “Magma Wellbore With Directional Drilling”; U.S. patent application Ser. No. 18/195,837, filed May 10, 2023, and titled “Molten Salt as Heat Transfer Fluid in Magma Geothermal System”; and U.S. patent application Ser. No. 18/141,326, filed Feb. 28, 2023, and titled “Casing a Wellbore in Magma”, the entirety of each of which is hereby incorporated by reference.

In another embodiment of the present disclosure, the geothermal system 300 may be lava-based. For example, the geothermal system 300 may include a horizontal wellbore or a wellbore that extends a shorter distance from the surface 216, such that the wellbore 302 extends from the surface 216 horizontally into the lava and/or from the surface 216 into a relatively shallow lava lake. The lava may be in a lava lake, lava flow, or other lava formation.

### Example Geothermal-Powered Drilling System

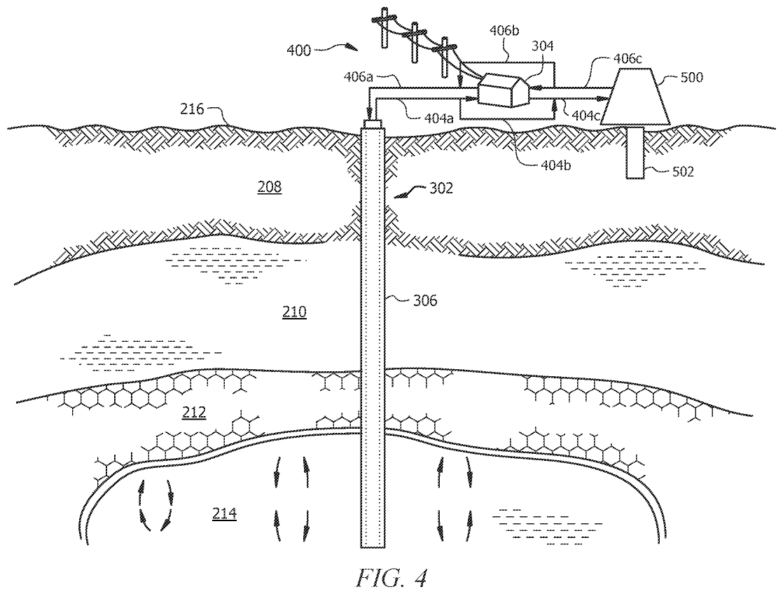

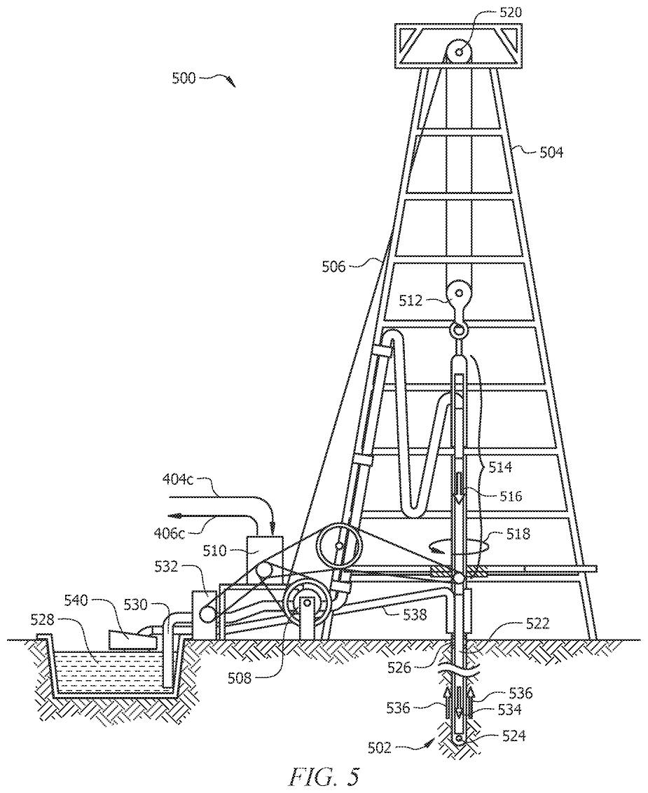

FIG. 4 illustrates an example drilling system 400 of this disclosure. The drilling system 400 includes all or a portion of the components of the geothermal system 300 described above with respect to FIG. 3 as well as thermally powered drilling equipment 500 for preparing a borehole 502. An example of the thermally powered drilling equipment 500 is described in greater detail below with respect to FIG. 5. The drilling system 400 may include all or a portion of the thermal process system 304. In operation, heated heat transfer fluid 404a (e.g., steam) from the wellbore 302 flows to the thermal process system 304 and/or bypasses the thermal process system 304 as heat transfer fluid 404b. The wellbore 302 extends from the surface 216 into the underground magma reservoir 214. The heat transfer fluid 406a is heated in the wellbore 302 via heat transfer with the underground magma reservoir 214. Any remaining steam from the thermal process system 304 and/or the heat transfer fluid 404b is provided as heat transfer fluid 404c to the thermally powered drilling equipment 500.

As described in greater detail below, the thermally powered drilling equipment 500 uses the heated heat transfer fluid 404c at least in part to drill borehole 502. For example, a motor of the thermally powered drilling equipment 500 may be powered by the heated heat transfer fluid 404c, and the motor may provide motion to a drill bit, fluid pump(s), and/or the like of the thermally powered drilling equipment 500 (see FIGS. 5-8 and corresponding description below). As another example, the thermally powered drilling equipment 500 may include a fluid pump with a motor that is powered at least in part by the heat transfer fluid 404c that was heated in the wellbore 302. As another example, the thermally powered drilling equipment 500 may include a motor that aids in moving the rotating drill bit into the surface 216 and is powered at least in part by heat transfer fluid 404c that was heated in the wellbore 302. More detailed examples of operations of thermally powered drilling equipment 500 are described below with respect to FIGS. 5-8.

Heat transfer fluid 406a (e.g., condensed steam) that is cooled and/or or decreased in pressure after powering the thermally powered drilling equipment 500 may be returned to the wellbore 302. For instance, as shown in the example of FIG. 4, a stream of return heat transfer fluid 406c may be provided back to the thermal process system 304, optionally used to drive one or more reactions or processes, and then expelled as heat transfer fluid 406a for return to the wellbore 302. The heat transfer fluid 406a can also include a bypass stream of heat transfer fluid 406b. Restated, thermally processed return stream of heat transfer fluid 406a includes heat transfer fluid (e.g., condensed steam) from the thermal process system 304 and/or the bypass stream of heat transfer fluid 406b. Thermally processed return stream of heat transfer fluid 406a that is sent back to the wellbore 302 may be water (or another heat transfer fluid), while the stream of heat transfer fluid 404a received from the wellbore 302 may be steam or another heat transfer fluid at an elevated temperature and/or pressure. While the example of FIG. 4 includes the thermal process system 304 of FIG. 3, in some cases, the drilling system 400 may exclude all or a portion of the thermal process system 304. For example, the wellbore stream of heat transfer fluid 404a from the wellbore 302 may be provided directly to the thermally powered drilling equipment 500 (see wellbore bypass stream of heat transfer fluid 404b described above).

Heat transfer fluid 404a-c, 406a-c may be any appropriate fluid for absorbing heat within the wellbore 302 and driving operations of the thermally powered drilling equipment 500 and, optionally the thermal process system 304. For example, the heat transfer fluid may include water, a brine solution, one or more refrigerants, a thermal oil (e.g., a natural or synthetic oil), a silicon-based fluid, a molten salt, a molten metal, or a nanofluid (e.g., a carrier fluid containing nanoparticles). A molten salt is a salt that is a liquid at the high operating temperatures experienced in the wellbore 302 (e.g., at temperatures between 1,600 and 2,300° F.). In some cases, an ionic liquid may be used as the heat transfer fluid. An ionic liquid is a salt that remains a liquid at more modest temperatures (e.g., at or near room temperature). In some cases, a nanofluid may be used as the heat transfer fluid. The nanofluid may be a molten salt or ionic liquid with nanoparticles, such as graphene nanoparticles, dispersed in the fluid. Nanoparticles have at least one dimension of 100 nanometers (nm) or less. The nanoparticles increase the thermal conductivity of the molten salt or ionic liquid carrier fluid. This disclosure recognizes that molten salts, ionic liquids, and nanofluids can provide improved performance as heat transfer fluids in the wellbore 302. For example, molten salts and/or ionic liquids may be stable at the high temperatures that can be reached in the wellbore 302. The high temperatures that can be achieved by these materials not only facilitate increased energy extraction but also can drive thermal processes that were previously inaccessible using previous geothermal technology. The heat transfer fluid may be selected at least in part to limit the extent of corrosion of surfaces of the drilling system 400. As an example, the heat transfer fluid may be water. The water is supplied to the wellbore 302 as stream of heat transfer fluid 406a in the liquid phase and is transformed into steam within the wellbore 302. The steam is received as stream of heat transfer fluid 404a and used to drive the thermally powered drilling equipment 500.

### Example Thermally Powered Drilling Equipment

FIG. 5 shows an example of the thermally powered drilling equipment 500 in greater detail. The configuration of FIG. 5 is provided as an example only. The thermally powered drilling equipment 500 may include more or fewer components, and the components may be arranged in different configurations in order to drill the borehole 502. The thermally powered drilling equipment 500 includes a derrick 504, drill line 506, hoisting equipment 508, one or more thermally powered motors 510, a traveling block 512, a drive system 514, a drill stem 522, a drill bit 524, a wellhead 526, a drilling fluid tank 528, a fluid pump 532, and a separation device 540.

The derrick 504 provides structural support for other components of the thermally powered drilling equipment 500 and facilitates the lowering and lifting of the drill bit 524 via these components. For example, the derrick 504 may be a supporting tower that holds other components of the thermally powered drilling equipment 500. The derrick 504 may have any appropriate structure. The derrick includes a support block 520 that is a stationary support for a drill line 506. The drill line 506 is a line that facilitates the transfer of motion from the hoisting equipment 508 to the traveling block 512. The drill line 506 is coupled to the hoisting equipment 508 and the traveling block 512. The hoisting equipment 508 includes a rotating surface that is in contact with the drill line 506. Rotation of the surface causes movement of the traveling block 512. The hoisting equipment 508 may be powered by the thermally powered motor(s) 510, as described further below.

The traveling block 512 connects the drill line 506 to other components used to rotate the drill bit 524 (e.g., the drive system 514 and drill stem 522), transport drilling fluid into and out of the borehole 502, and the like. The traveling block 512 may include pulleys that facilitate motion of the traveling block 512 via motion imparted to the drill line 506 via hoisting equipment 508. In the example of FIG. 5, the traveling block 512 is coupled to a drive system 514. For example, movement of the traveling block 512 may be used to impart a downward movement 516 of the drill stem 522 and the drill bit 524 to facilitate creation of the borehole 502. The drill stem 522 may include a drill pipe consisting of tool joints, a swivel, a bit, a drill string, drill collars, drives, subs, a top drive, shock absorbers, reamers and/or any other related equipment used during the drilling process.

The drive system 514 facilitates the rotational movement 518 of the drill stem 522 and thereby imparts a rotational force or torque to the drill bit 524. The drive system may include a swivel, kelly drive, and turntable, as shown in the example of FIG. 5, or the drive system 514 may be a top drive or other appropriate equipment for generating the rotational movement 518. The drive system 514 causes rotational movement 518 of the drill bit 524. The drive system 514 may be powered at least in part by the thermally powered motor(s) 510, as described further below.

The drill bit 524 can be any appropriate type of currently used or future-developed drill bit for forming the borehole 502. For example, the drill bit 524 may be a tri-cone drill bit with an integrated underreamer (not shown) that projects radially outward to aid in positioning a casing (not shown for clarity and conciseness) within the borehole 502. For example, an underreamer may be withdrawn or retracted to allow the drill bit 524 to be extracted from the borehole 502 without simultaneously extracting the well casing. One or more ejection nozzles (not shown for conciseness) may be positioned on the drill bit 524 and/or drill stem 522 to supply drilling fluid during drilling operations. For example, drilling fluid may be supplied at an increased pressure to improve the removal of material within the borehole 502.

The wellhead 526 includes fluid connections, valves, and the like for facilitating appropriate operation of the drilling system 400. For example, the wellhead 526 may include one or more valves to control pressure within the borehole 502. The wellhead 526 may include a relief valve for venting the borehole 502 if an excessive pressure is reached.

The fluid pump 532 facilitates flow of drilling fluid into the borehole 502 and flow 536 of drilling fluid out of the borehole 502. The fluid pump 532 is any appropriate pump capable of pumping drilling fluid. Fluid tank 528 stores drilling fluid that is pumped through fluid conduit 530. The fluid pump 532 provides fluid flow 534 through the conduit 530. The drilling fluid aids in the drilling process and then returns with solids (e.g., cuttings from the borehole 502) via flow 536 through return conduit 538. The returned drilling fluid from conduit 538 is filtered by a separation device 540 before being returned to the fluid tank 528. The separation device 540 removes at least a portion of the solids from the drilling fluid that is returned to the fluid tank 528 for reuse in the drilling process. The fluid pump 532 may be powered at least in part by the thermally powered motor(s) 510, as described further below.

The one or more thermally powered motors 510 are powered at least in part by heat transfer fluid heated in the wellbore 302 (e.g., as heat transfer fluid 406c of FIG. 4). Cooled and/or condensed heat transfer fluid (e.g., water) may be provided back to the wellbore 302 as heat transfer fluid 404c (see also FIGS. 4, 6, and 7). A thermally powered motor 510 may use the heat transfer fluid heated in the geothermal wellbore 302 to rotate the drill bit 524. For example, the thermally powered motor 510 may power the drive system 514 (described above). For example, a thermally powered motor 510 may be a steam-powered motor that uses steam from heat transfer fluid 404c heated in wellbore 302.

In some cases, a thermally powered motor 510 may use the heat transfer fluid heated by the geothermal wellbore 302 to move the rotating drill bit 524 into the surface 216 to form borehole 502. For example, the thermally powered motor 510 may power the hoisting equipment 508 which is used move the drill line 506 and in turn impart downward movement 516 to the drill stem 522 and drill bit 524. Other mechanisms for moving the drill bit 524 downwards may be used with a thermally powered motor 510 driving the downward motion.

In some cases, thermally powered motor 510 may use the heat transfer fluid heated by the geothermal wellbore 302 (heat transfer fluid 406c) to power the fluid pump 532, which provides a flow of drilling fluid into the borehole 502 being drilled by the drill bit 524.

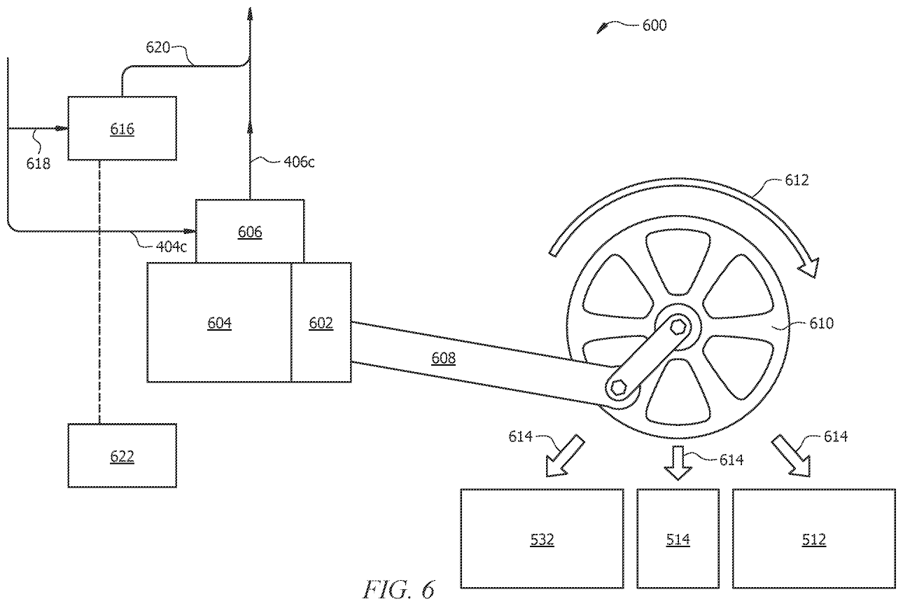

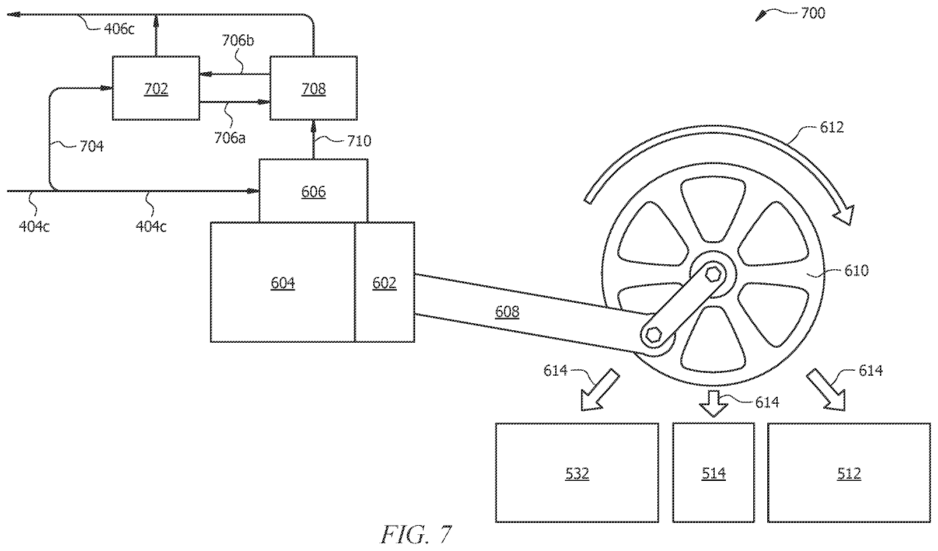

Examples of a thermally powered motors 510 are described below with respect to FIGS. 6 and 7. FIG. 6 shows a thermally powered motor 600 which may be used as thermally powered motor 510 of FIG. 5. Thermally powered motor 600 includes a piston 602 within a cylinder 604. One or more valves 606 control introduction of heat transfer fluid 404c (e.g., steam) into the cylinder 604, such that the piston 602 moves within the cylinder 604. A rod 608 is connected to the piston 602 and to a flywheel 610. Movement of the piston 602 within the cylinder 604 causes the flywheel 610 to rotate (movement 612). The flywheel 610 is in turn coupled to the drill bit 524, such that rotation of the flywheel 610 causes the drill bit 524 to rotate. This may be achieved, for example, by transferring energy 614 or motion from the flywheel 610 to the drive system 514 (see FIG. 5). The flywheel 610 may also or alternatively be coupled to the hoisting equipment 514 to move the drill bit 524 up and down (see FIG. 5). The flywheel 610 may also or alternatively be coupled to the fluid pump 532 to drive the flow of drilling fluid (see FIG. 5).

In the example of FIG. 6, the thermally powered motor 600 includes one or more turbines 616 that generate electricity using the heat transfer fluid heated by the wellbore 302. For example, a portion 618 of heat transfer fluid 404c may be provided to the turbine(s) 616 to generate electricity. Condensed heat transfer fluid from the turbines(s) 616 is provided back to the wellbore 302 as a stream 620 which is included in heat transfer fluid 406c. The turbine(s) 616 may be any known or yet to be developed turbine for electricity generation. In some cases, the electricity may be used to power electrical components 622 used by a drilling system (e.g., system 400 of FIG. 4). The electrical components 622 may include sensors, control devices, electronic valves, electronic switches, and the like. For example, the electrical components 622 may include temperature and pressure sensors used in the drilling system 400, control devices used to interpret information from these sensors, and switches to adjust operation of the system 400 based on sensor data.

FIG. 7 shows another example thermally powered motor 700, which may be used as motor 510 of FIG. 5. The example thermally powered motor 700 includes several of the same components illustrated in FIG. 6 and described above. However, the thermally powered motor 700 differs from thermally powered motor 600 by including an absorption chiller 702 and condenser 708. The absorption chiller 702 receives a portion 704 of heat transfer fluid 404c heated by the wellbore 302. The portion 704 of heat transfer fluid 404c is used by the absorption chiller 702 to cool a cooling fluid. A flow 706a of cooled cooling fluid is provided to the condenser 708. The condenser 708 transfers heat from stream 710 of heat transfer fluid 404c from the valve(s) 606 to the flow 706a in order to further cool and/or condense the heat transfer fluid 406c that is provided back to the wellbore 302. A flow 706b of heated cooling fluid is sent back to the absorption chiller 702 to be cooled. In some cases, a thermally powered motor 510 of FIG. 5 may include both turbine(s) 616 of FIG. 6 and an absorption chiller 702 of FIG. 7 as well as other components not explicitly described.

### Example Method of Operating a Thermally Powered Drilling System

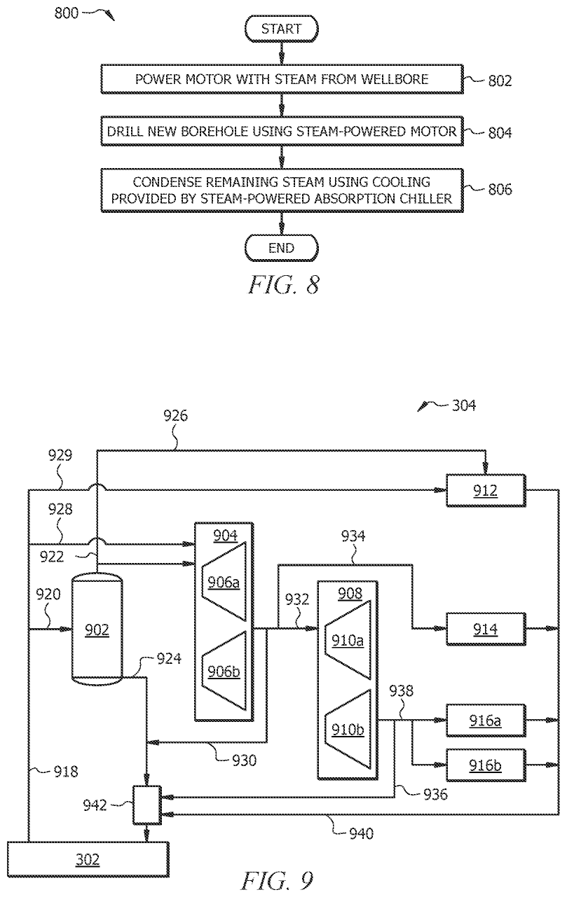

FIG. 8 illustrates an example method 800 of operating the drilling system 400 of FIG. 4. The method 800 may begin at step 802 where the thermally powered motor 510 is powered by heat transfer fluid obtained from wellbore 302, as described above with respect to FIGS. 4-7. At step 804, a borehole 502 is drilled using power (or force, motion, etc.) provided by the thermally powered motor 510. At step 806, heat transfer fluid is cooled and/or condensed and provided back to the wellbore 302. Step 806 may be performed using the absorption chiller 702 described with respect to FIG. 7 above.

Modifications, omissions, or additions may be made to method 800 depicted in FIG. 8. Method 800 may include more, fewer, or other steps. For example, at least certain steps may be performed in parallel or in any suitable order. While at times discussed as thermally powered drilling system 400 being used to perform steps, any suitable component(s) may perform or may be used to perform one or more steps of the method 800.

### Example Thermal Processing Subsystem

FIG. 9 shows a schematic diagram of an example thermal process system 304 of FIGS. 3 and 4. The thermal process system 304 includes a steam separator 902, a first turbine set 904, a second turbine set 908, a high-temperature/pressure thermochemical process 912, a medium-temperature/pressure thermochemical process 914, and one or more lower temperature/pressure processes 916a,b. The thermal process system 304 may include more or fewer components than are shown in the example of FIG. 9. For example, a thermal process system 304 used for power generation alone may omit the high-temperature/pressure thermochemical process 912, medium-temperature/pressure thermochemical process 914, and lower temperature/pressure processes 916a,b. Similarly, a thermal process system 304 that is not used for power generation may omit the turbine sets 904, 908. As a further example, if heat transfer fluid is known to be received only in the gas phase, the steam separator 902 may be omitted in some cases. The ability to tune the properties of the heat transfer fluid received from the unique wellbore 302 of FIGS. 3 and 4 facilitates improved and more flexible operation of the thermal process system 304. For example, the depth of the wellbore 302, the residence time of heat transfer fluid in the magma reservoir 214, the pressure achieved in the wellbore 302, and the like can be selected or adjusted to provide desired heat transfer fluid properties at the thermal process system 304.

In the example of FIG. 9, the steam separator 902 is connected to the wellbore 302 that extends between a surface and the underground magma reservoir. The steam separator 902 separates a vapor-phase heat transfer fluid (e.g., steam) from liquid-phase heat transfer fluid (e.g., condensate formed from the vapor-phase heat transfer fluid). A stream 920 received from the wellbore 302 may be provided to the steam separator 902. In some cases, all of stream 918 is provided in stream 920. In other cases, a fraction or none of stream 918 is provided to the steam separator 902. Instead, all or a portion of the stream 918 may be provided as stream 928 which may be provided to the first turbine set 904 and/or to a high-pressure thermal process 912 in stream 929. The thermal process 912 may be a thermochemical reaction requiring high temperatures and/or pressures (e.g., temperatures of between 500 and 2,000° F. and/or pressures of between 1,000 and 4,500 psig), such as the thermally powered drilling equipment 500. One or more valves (not shown for conciseness) may be used to control the direction of stream 920 to the steam separator 902, first turbine set 904, and/or thermal process 912. A vapor-phase stream 922 of heat transfer fluid from the steam separator 902 may be sent to the first turbine set 904 and/or the thermal process 912 via stream 926. A liquid-phase stream 924 of heat transfer fluid from the steam separator 902 may be provided back to the wellbore 302 and/or to condenser 942. The condenser 942 is any appropriate type of condenser capable of condensing a vapor-phase fluid. The condenser 942 may be coupled to a cooling or refrigeration unit, such as a cooling tower (not shown for conciseness).

The first turbine set 904 includes one or more turbines 906a,b. In the example of FIG. 9, the first turbine set includes two turbines 906a,b. However, the first turbine set 904 can include any appropriate number of turbines for a given need. The turbines 906a,b may be any known or yet to be developed turbine for electricity generation. The first turbine set 904 is connected to the steam separator 902 and is configured to generate electricity from the vapor-phase heat transfer fluid (e.g., steam) received from the steam separator 902 (vapor-phase stream 922). A stream 930 exits the first turbine set 904. The stream 930 may be provided to the condenser 942 and then back to the wellbore 302. The condenser 942 may be cooled using a heat driven chiller, such as the absorption chiller 702 of FIG. 7.

If the heat transfer fluid is at a sufficiently high temperature, as may be uniquely and more efficiently possible using the wellbore 302, a stream 932 of vapor-phase heat transfer fluid may exit the first turbine set 904. Stream 932 may be provided to the second turbine set 908 to generate additional electricity. The turbines 910a,b of the second turbine set 908 may be the same as or similar to turbines 906a,b, described above.

All or a portion of stream 932 may be sent as vapor-phase stream 934 to a thermal process 914. Process 914 is generally a process requiring vapor-phase heat transfer fluid at or near the conditions of the heat transfer fluid exiting the first turbine set 904. For example, the thermal process 914 may include one or more thermochemical processes requiring steam or another heat transfer fluid at or near the temperature and pressure of stream 932 (e.g., temperatures of between 250 and 1,500° F. and/or pressures of between 500 and 2,000 psig). The second turbine set 908 may be referred to as “low pressure turbines” because they operate at a lower pressure than the first turbine set 904. Fluid from the second turbine set 908 is provided to the condenser 942 via stream 936 to be condensed and then sent back to the wellbore 302 via stream 936.

An effluent stream 938 from the second turbine set 908 may be provided to one or more thermal processes 916a,b. Thermal processes 916a,b generally require less thermal energy than thermal processes 912 and 914, described above (e.g., processes 916a,b may be performed temperatures of between 220 and 700° F. and/or pressures of between 15 and 120 psig). As an example, processes 916a,b may include water distillation processes, heat-driven chilling processes, space heating processes, agriculture processes, aquaculture processes, and/or the like. For instance, an example heat-driven chiller process 916a may be implemented using one or more heat driven chillers. Heat driven chillers can be implemented, for example, in data centers, crypto-currency mining facilities, or other locations in which undesirable amounts of heat are generated. Heat driven chillers, also referred to as absorption cooling systems, use heat to create chilled water. Heat driven chillers can be designed as direct-fired, indirect-fired, and heat-recovery units. When the effluent includes low pressure steam, indirect-fired units may be preferred. An effluent stream 940 from all processes 912, 914, 916a,b, may be provided back to the wellbore 302. This disclosure describes example systems that may facilitate improved and/or more efficient drilling using geothermal energy. While these example systems are described as employing heating through thermal contact with a magma reservoir 214, it should be understood that this disclosure also encompasses similar systems in which another thermal reservoir or heat source is harnessed. For example, heat transfer fluid may be heated by underground water at an elevated temperature. As another example, heat transfer fluid may be heated by radioactive material emitting thermal energy underground or at or near the surface. As yet another example, heat transfer fluid may be heated by lava, for example, in a lava lake or other formation. As such, the magma reservoir 214 of FIGS. 3 and 4 may be any thermal reservoir or heat source that is capable of heating heat transfer fluid to achieve desired properties (e.g., of temperature and pressure). Furthermore, the thermal reservoir or heat source may be naturally occurring or artificially created (e.g., by introducing heat underground that can be harnessed at a later time for energy generation or other thermal processes).

### ADDITIONAL EMBODIMENTS

The following descriptive embodiments are offered in further support of the one or more aspects of this disclosure.

Embodiment 1. A drilling system, comprising:
a geothermal system comprising a wellbore extending from a surface into an underground magma reservoir, the wellbore configured to heat a heat transfer fluid via heat transfer with the underground magma reservoir;
a drill rig comprising:
   a drill bit; and
   a steam-powered motor configured to use the heat transfer fluid heated by the geothermal system to rotate the drill bit, and optionally one or more of the following features:
wherein the steam-powered motor is further configured to use the heat transfer fluid heated by the geothermal system to move the rotating drill bit into the surface;
wherein the steam-powered motor is further configured to use the heat transfer fluid heated by the geothermal system to drive a pump configured to provide a flow of drilling fluid into a borehole drilled by the drill bit;
wherein the steam-powered motor comprises:
   a piston within a cylinder;
   one or more valves configured to control introduction of steam into the cylinder, such that the piston moves within the cylinder; and
   a rod connected to the piston and to a flywheel, wherein movement of the piston within the cylinder causes the flywheel to rotate, wherein the flywheel is coupled to the drill bit, such that rotation of the flywheel causes the drill bit to rotate;
the system further comprising:
an absorption chiller configured to:
   receive heat transfer fluid heated by the geothermal system; and
   generate a cooling fluid using the received heat transfer fluid; and
a condenser configured to:
   receive the cooling fluid; and
   condense the heat transfer fluid via heat transfer with the received cooling fluid before the heat transfer fluid is returned to the wellbore of the geothermal system;
the system further comprising one or more turbines configured to generate electricity using the heat transfer fluid heated by the geothermal system; and/or
wherein the heat transfer fluid comprises water.

Embodiment 2. A method comprising:
providing a heat transfer fluid down a wellbore extending from a surface and into an underground reservoir of magma;
receiving heated heat transfer fluid from the wellbore; and
powering drilling equipment using the heated heat transfer fluid to drill a borehole, and
optionally one or more of the following features:
wherein powering the drilling equipment comprises:
   causing a steam-powered motor to rotate;
   causing a drill bit coupled to the steam-powered motor to rotate; and
   cause the rotating frill bit to move into the surface;
wherein powering the drilling equipment comprises:
   using the heat transfer fluid heated by the geothermal system to drive a pump; and
   providing, using the pump, a flow of drilling fluid into the borehole drilled by the drill bit;
wherein the steam-powered motor comprises:
   a piston within a cylinder;
   one or more valves configured to control introduction of steam into the cylinder, such that the piston moves within the cylinder; and
   a rod connected to the piston and to a flywheel, wherein movement of the piston within the cylinder causes the flywheel to rotate, wherein the flywheel is coupled to the drill bit, such that rotation of the flywheel causes the drill bit to rotate;
the method further comprising:
   receiving, by an absorption chiller, the heat transfer fluid heated by the geothermal system;
   generating, by the absorption chiller, a cooling fluid using the received heat transfer fluid;
   receiving, by a condenser, the cooling fluid; and
   condensing, by the condenser, the heat transfer fluid via heat transfer with the received cooling fluid before the heat transfer fluid is returned to the wellbore of the geothermal system;
the method further comprising:
   generating electricity using the heat transfer fluid heated by the geothermal system; and
   using at least a portion of the generated electricity for powering the drilling equipment; and/or
wherein the heat transfer fluid comprises water and the heated heat transfer fluid comprises steam.

Embodiment 3. A steam-powered motor comprising:
a piston within a cylinder;
one or more valves configured to:
   receive steam heated in a wellbore extending from a surface into an underground magma reservoir; and
   control introduction of steam into the cylinder, such that the piston moves within the cylinder; and
a rod connected to the piston and to a flywheel, wherein movement of the piston within the cylinder causes the flywheel to rotate.

Although embodiments of the disclosure have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments. Moreover, items shown or discussed as coupled or directly coupled or communicating with each other may be indirectly coupled or communicating through some interface device, or intermediate component whether electrically, mechanically, fluidically, or otherwise.

While this disclosure has been particularly shown and described with reference to preferred or example embodiments, it will be understood by those skilled in the art that various changes in form and detail may be made therein without departing from the spirit and scope of the disclosure. Accordingly, this disclosure includes all modifications and equivalents of the subject matter recited in the claims appended hereto as permitted by applicable law. Changes, substitutions and alterations are ascertainable by one skilled in the art and could be made without departing from the spirit and scope disclosed herein. Moreover, any combination of the above-described elements in all possible variations thereof is encompassed by the disclosure unless otherwise indicated herein or otherwise clearly contradicted by context.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

What is claimed is:

1. A drilling system, comprising:
a geothermal system comprising a wellbore extending from a surface into an underground magma reservoir, the wellbore configured to heat a heat transfer fluid via heat transfer with the underground magma reservoir;
a drill rig comprising:
a drill bit; and
a steam-powered motor configured to use the heat transfer fluid heated by the geothermal system to rotate the drill bit.

2. The drilling system of claim 1, wherein the steam-powered motor is further configured to use the heat transfer fluid heated by the geothermal system to move the rotating drill bit into the surface.

3. The drilling system of claim 1, wherein the steam-powered motor is further configured to use the heat transfer fluid heated by the geothermal system to drive a pump configured to provide a flow of drilling fluid into a borehole drilled by the drill bit.

4. The drilling system of claim 1, wherein the steam-powered motor comprises:
a piston within a cylinder;
one or more valves configured to control introduction of steam into the cylinder, such that the piston moves within the cylinder; and
a rod connected to the piston and to a flywheel, wherein movement of the piston within the cylinder causes the flywheel to rotate, wherein the flywheel is coupled to the drill bit, such that rotation of the flywheel causes the drill bit to rotate.

5. The drilling system of claim 1, further comprising:
an absorption chiller configured to:
receive heat transfer fluid heated by the geothermal system; and
generate a cooling fluid using the received heat transfer fluid; and
a condenser configured to:
receive the cooling fluid; and
condense the heat transfer fluid via heat transfer with the received cooling fluid before the heat transfer fluid is returned to the wellbore of the geothermal system.

6. The drilling system of claim 1, further comprising one or more turbines configured to generate electricity using the heat transfer fluid heated by the geothermal system.

7. The drilling system of claim 1, wherein the heat transfer fluid comprises water.

8. A method comprising:
providing a heat transfer fluid down a wellbore extending from a surface and into an underground reservoir of magma;
receiving heated heat transfer fluid from the wellbore; and
powering drilling equipment using the heated heat transfer fluid to drill a borehole.

9. The method of claim 8, wherein powering the drilling equipment comprises:
causing a steam-powered motor to rotate;
causing a drill bit coupled to the steam-powered motor to rotate; and
cause the rotating frill bit to move into the surface.

10. The method of claim 9, wherein powering the drilling equipment comprises:
using the heat transfer fluid heated by the geothermal system to drive a pump;
providing, using the pump, a flow of drilling fluid into the borehole drilled by the drill bit.

11. The method of claim 9, wherein the steam-powered motor comprises:
a piston within a cylinder;
one or more valves configured to control introduction of steam into the cylinder, such that the piston moves within the cylinder; and
a rod connected to the piston and to a flywheel, wherein movement of the piston within the cylinder causes the flywheel to rotate, wherein the flywheel is coupled to the drill bit, such that rotation of the flywheel causes the drill bit to rotate.

12. The method of claim 8, further comprising:
receiving, by an absorption chiller, the heat transfer fluid heated by the geothermal system;
generating, by the absorption chiller, a cooling fluid using the received heat transfer fluid;
receiving, by a condenser, the cooling fluid; and
condensing, by the condenser, the heat transfer fluid via heat transfer with the received cooling fluid before the heat transfer fluid is returned to the wellbore of the geothermal system.

13. The method of claim 8, further comprising:
generating electricity using the heat transfer fluid heated by the geothermal system; and
using at least a portion of the generated electricity for powering the drilling equipment.

14. The method of claim 8, wherein the heat transfer fluid comprises water and the heated heat transfer fluid comprises steam.

15. A steam-powered motor comprising:
a piston within a cylinder;
one or more valves configured to:
receive steam heated in a wellbore extending from a surface into an underground magma reservoir; and
control introduction of steam into the cylinder, such that the piston moves within the cylinder; and
a rod connected to the piston and to a flywheel, wherein movement of the piston within the cylinder causes the flywheel to rotate.
